(19) United States
(12) Patent Application Publication
(10) Pub. No.: US 2010/0074256 A1
(43) Pub. Date: Mar. 25, 2010

(54) SERVICE RECOGNITION METHOD OF ROUTER IN IPV6 ENVIRONMENT

(75) Inventors: Joo-Myoung Seok, Daejeon (KR); Yoo-Hwa Kang, Daegu (KR); Han-Kyu Lee, Daejon (KR); Jin-Woo Hong, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/443,375

(22) PCT Filed: Dec. 26, 2006
(86) PCT No.: PCT/KR06/05710

§ 371 Date: Mar. 27, 2009

(30) Foreign Application Priority Data
Sep. 29, 2006 (KR) 10-2006-0095559

(51) Int. Cl. H04L 12/56

(52) U.S. Cl. 370/392

(57) ABSTRACT

Provided is a service recognition method of a router in IPv6 environment, allowing a router to facilitate access of a mobile terminal to various services by using service information of a service header and identification information of the mobile terminal included in an IPv6 packet transmitted from the mobile terminal. The service recognition method includes: a) looking up predefined service cache by using service identification of IPv6 packet as index key of the service cache when the IPv6 packet including the service ID in a service header is received from the mobile terminal; b) changing destination address into address of the service server when the address of the service server and service control information are determined through the lookup of the service-cache to request service and perform service control; and c) routing to the mobile terminal by using the IPv6 packet when service response is transmitted from the service server.

### TECHNICAL FIELD

The present invention relates to a service recognition method of a router in an Internet Protocol version 6 (IPv6) environment; and, more particularly, to a service recognition method of a router in an IPv6 environment, which allows a router to facilitate access of a mobile terminal to various services by using service information of a service header and identification information of the mobile terminal included in an IPv6 packet transmitted from the mobile terminal.

### BACKGROUND ART

As a fixed-mobile convergence environment is developed, service providers are creating new services by converging and bundling existing services.

In the case where services are provided with diversity in kinds according to characteristics of service providers, a terminal must recognize and access the services in various manners defined differently by services or providers.

For this reason, a current router is being continuously developed from a simple IP data transfer function to a service recognition function. For example, in an Internet Protocol version 4 (IPv4) environment, the router recognizes or classifies a service by using a destination IPv4 address, a source IPv4 address, a destination port number, a source port number, and a protocol number in an IP network layer. Through such functions, the service providers are making effort to provide a user with quality of service (QoS) and grade of service (GoS).

However, the router in the IPv4 environment must perform parsing and lookup of an IP network layer or higher, thereby deteriorating a delivery function over an IP network.

A service recognition function of the router in the IPv4 environment will now be described in detail.

For routing, the router receives an IPv4 packet, learns an IPv4 destination address, and looks up a forwarding information base (FIB) table. In order to perform service recognition as well as the routing, the router learns an IPv4 source address and a protocol number as well as the IPv4 destination address, which are included in an IPv4 header, and then examines a protocol header corresponding layer 4 of IPv4 data to learn a protocol port number. In the typical IPv4 environment, a specific service is indicated by using a protocol number or a protocol port number, e.g., a transmission control protocol (TCP) port number, in an IPv4 packet. That is, the router examines the protocol number or the protocol port number, e.g., an IP layer corresponding to layer 3 or a transport layer corresponding to layer 4 to recognize the service. Also, the router looks up a layer-4 table with the recognized information to determine a corresponding service, and performs required service control, e.g., QoS marking.

As mentioned above, the router looks up layer 3, i.e., the IP layer for general routing, but also looks up layer 4, i.e., the transport layer as well as the IP layer with respect to every packet for service control. For this reason, even the general routing function of the router is deteriorated. Particularly, In the case of an IPv6 environment using an IPv6 extension header, the router requires more time to look up a protocol header of layer 4 than in the IPv4 environment.

Also, when an IPv4 packet is encapsulated for tunneling or is encrypted, it is difficult for the router to examine internal data thereof. Also, when a port is dynamically negotiated and changed, it is difficult for the router to accurately recognize a service because a fixed service ID is not used. For example, in the case of encapsulation security payload (IPSEC ESP) tunneling or generic routing encapsulation (GRE) tunneling, it is difficult for the router to obtain a service indemnification (ID) in an IPv4 packet.

In addition, the router cannot accurately recognize a service because it estimates a corresponding service based on source/destination IPv4 addresses, a protocol number, and source/destination protocol port numbers.

As the next-generation Internet environment is evolving from IPv4 to IPv6, the router is required to perform accurate service recognition for providing various services, while retaining routing performance.

Also, the router must be able to request service control in common for a variety of services.

### DISCLOSURE

### Technical Problem

An embodiment of the present invention is directed to providing a service recognition method of a router in an Internet Protocol version 6 (IPv6) environment, which is configured to allow a router to facilitate access of a mobile terminal to various services by using service information of a service header and identification information of the mobile terminal included in an IPv6 packet transmitted from the mobile terminal.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a service recognition method of a router in an Internet protocol version 6 (IPv6) environment including a mobile terminal transmitting an IPv6 packet to request service, and a service server responding to a service request, the service recognition method including the steps of: a) looking up a predefined service cache by using a service identification (ID) of an IPv6 packet as an index key of the service cache when the IPv6 packet including the service ID in a service header is received from the mobile terminal; b) changing a destination address to an address of the service server when the address of the service server and service control information are determined through the lookup of the service-cache, to request a service and perform service control; and c) performing routing to the mobile terminal by using the IPv6 packet when there is a service response from the service server.

### ADVANTAGEOUS EFFECTS

In accordance with an embodiment of the present invention, when it is necessary to control a service required by a mobile terminal in an IPv6 environment, a router can recognize the service by using a service ID indicated in a service header.

In accordance with an embodiment of the present invention, in order to obtain service information, the mobile terminal requests a service from the router without obtaining the corresponding information from a service repository, so that it is unnecessary to configure additional information for service.

In accordance with an embodiment of the present invention, the router can accurately differentiate a service by using a service ID without requiring another service protocol for service control, so that the router is prevented from performing control different from an actual service.

In accordance with an embodiment of the present invention, since a service header in an IPv6 extension header format is used, the service can be recognized at an IP layer.

In accordance with an embodiment of the present invention, since the router recognizes a service at an IP layer, separate lookup of layer 4 is not necessary for service recognition, thereby preventing performance deterioration.

In accordance with an embodiment of the present invention, a service header including a service ID is used, so that accurate service control can be performed for various services in the IPv6 environment, and service recognition performance of the router can be improved, eliminating load of the mobile terminal due to information management associated with the service.

In accordance with an embodiment of the present invention, extension of service control is facilitated such as QoS allocation, service authentication, anycast service, and access to VOD/IPTV/VOIP server, and an extensible IPv6 service is supported at the time of handover in a fixed-mobile convergence network.

### BRIEF DESCRIPTION OF THE DRAWINGS

FIG. 1 is a view for explaining a service header of an IPv6 in accordance with an embodiment of the present invention.

FIG. 2 is a flow diagram of a service recognition method of a router in an IPv6 environment in accordance with an embodiment of the present invention.

FIG. 3 is a flow diagram of a process of performing a quality of service (QoS) service by using a service header in accordance with an embodiment of the present invention.

FIG. 4 is a view for explaining a process of performing handover of a mobile terminal by using a service header in accordance with an embodiment of the present invention.

FIG. 5 is a view for explaining a process of performing a service for IPv6 communications between a mobile terminal and a service server by using a service header in accordance with an embodiment of the present invention.

### BEST MODE FOR THE INVENTION

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

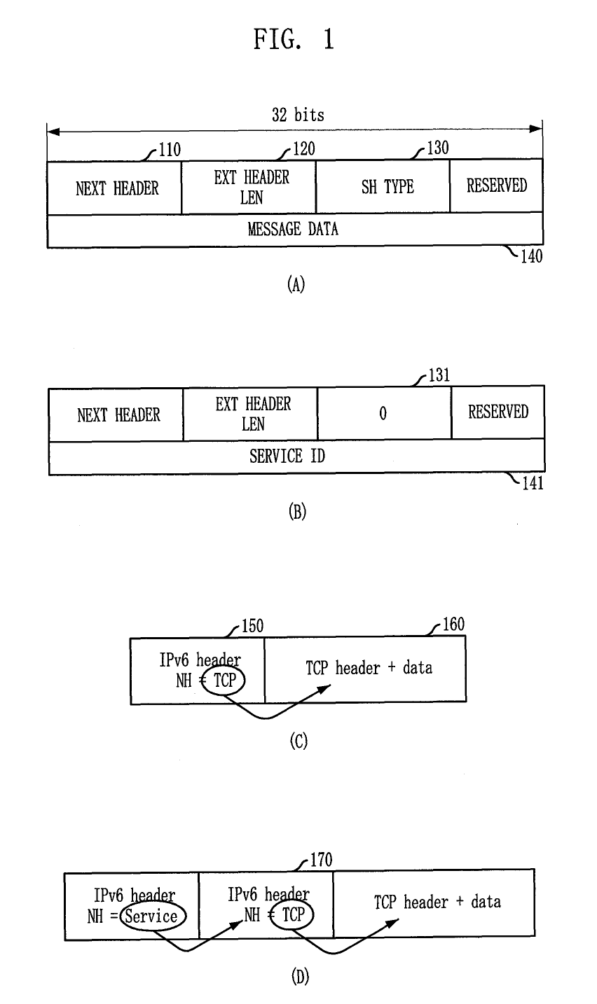

FIG. 1 is a view for explaining a service header in accordance with an embodiment of the present invention.

Before description is made with reference to FIG. 1, a structural difference between an IPv6 header and an IPv4 header will be briefly made. That is, an IPv4 header has a structure including fixed fields and option fields. In comparison, an IPv6 header has an extension header structure that allows independent and flexible indication of header information on the basis of each piece of information. The option fields of the IPv4 header are defined as an IPv6 extension header. Accordingly, the IPv6 can provide flexibility when a new option is introduced due to emergence of a new application service.

Referring to FIG. 1(A), a service header of the IPv6 follows a format of an IPv6 extension header and includes a next header field 110, a header extension length field 120, a service header type field 130, and a message data field 140. The service header of the IPv6 is used without adding separate functions.

The next header field 110 is an 8-bit selector and identifies the type of a header following the service header. The next header field 110 uses the same value as the IPv4 protocol field.

The header extension length field 120 is an 8-bit unsigned integer, and indicates a length of the service hear, not including the first 8 octets. The header extension length field 120 is in 8-octet units.

The service type field 130 is an 8-bit identifier for a specific service header change.

The message data field 140 is a variable length field, and includes data associated with the service header type 130.

In the service header in accordance with an embodiment of the present invention, the message data 140 can be defined according to the service header type 130. That is, a new service header type 130 can be added in the service header, and the message data 140 according to the service header type 130 may indicate various services, besides service identification (ID). Examples of the various services include a virtual private network (VPN) ID, multicast, unicast, anycast, video on demand (VOD), and voice over Internet protocol (VoIP).

For example, referring to FIG. 1(B), when the service header type 130 is “0” as indicated by a reference numeral 131, the message data 140 is used as a service ID 141 in a service header in accordance with an embodiment of the present invention.

Like a reserved field Reserved0, the service header type field 130 is initialized to “0” for transmission, and can be ignored on reception.

The service ID 141 refers to a predefined 32-bit protocol port number or a newly defined service number. The service ID 141 is used as an index key in looking up a service cache. The service cache includes service control information required by a default router.

In detail, the service cache includes a table including a service quality mark value that can be used in an IPv6 header, and service quality filter information that can be mirrored in the router and be used for monitoring service-quality retention. Thus, through service-cache lookup, the default router performs service recognition, and modification and regeneration of an IPv6 packet based on service information. That is, the default router performs service-cache lookup by using the service ID as an index key, thereby learning an adjacent service server address, and retaining service quality standard and service quality.

A mobile terminal does not need to extract service information required for a service request from a service repository, and requests a service directly from the default router by using the service header. The default router recognizes a service using the service header at the IP layer, and performs various service control such as QoS, filtering, and access to VOD/Internet protocol television (IPTV)/VoIP server.

AS shown in FIGS. 1(C) and 1(D), the service header 170 follows an IPv6 extension header format in which selectable Internet data are encoded in separate headers. That is, the service header 170 can be placed between an IPv6 header and an upper layer header 160. The service header 170 is placed at the last of a predefined IPv6-extension-header alignment order and in front of the upper layer header 160, thereby providing compatibility between a router supporting the service header and a router supporting no service header.

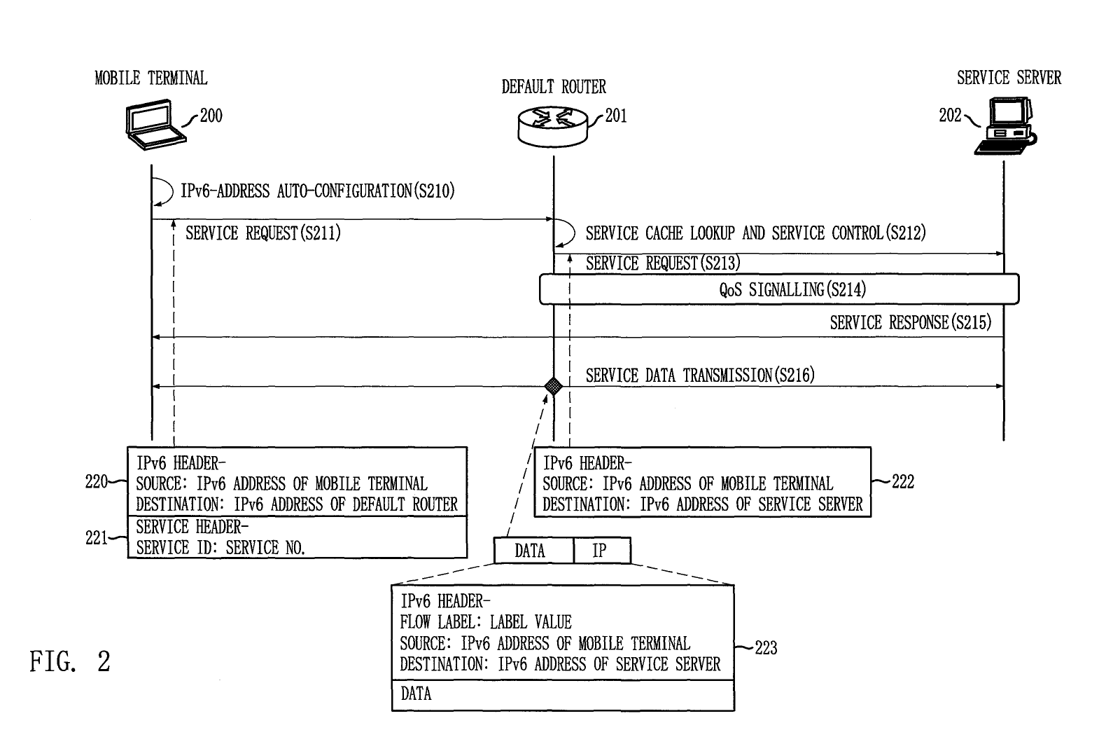

FIG. 2 is a flow diagram of a service recognition method of a router in an IPv6 environment in accordance with an embodiment of the present invention. The router 201 is a default router.

Referring to FIG. 2, in step S210, a mobile terminal 200 configures an interface address of the mobile terminal 200 through Ipv6 address auto-configuration by using an IPv6 prefix sent from a default router 201 in initialization, and learns an address of the default router 201.

In step S211, the mobile terminal 200 transmits an IPv6 packet including a service header 221, and requests a service from the default router 201. A source address in the IPv6 header 220 is an IPv6 address of the mobile terminal 200, and a destination address of the IPv6 header 220 is an IPv6 address of the default router 201. The service header 221 includes a service ID, i.e., a service number, and is extensible depending on the purpose of the service.

In step S212, when receiving the Ipv6 packet from the mobile terminal 200, the default router 201 decodes the IPv6 packet and looks up a predefined service cache by using the service ID in the service header 221 as a key. The default router 201 acquires an address of a service server 202 providing the service from the service cache, or performs necessary service control.

That is, the mobile terminal 200 does not need to request and receive service information from a service repository, but requests a corresponding service from the service server 202 unlike an IPv4 environment.

In step S213, the default router 201 automatically request the service from the service server 202 according to an adjacent service server address determined through the service-cache lookup. That is, the default router 201 changes the destination address to an IPv6 address of the service server 202 in an IPv6 header 222 of the IPv6 packet received from the mobile terminal 200 and from which the service header has been stripped off, thereby performing routing in an IPv6 network environment.

Since the mobile terminal 200 does not need to configure a separate address or associated information for the service, the mobile terminal 200 can request the service without any further configuration provided that it is turned ON by a user.

In step S214, the default router 201 performs signaling for QoS control with the service server 202.

In the IPv6 environment, the default router 201, not the mobile terminal 200, performs service session and QoS signaling, while the mobile terminal 200 performs only the service request. In comparison, in the IPv4 environment, a mobile terminal directly performs service session and QoS signaling with a service repository and a service server to receive a service.

In step S215, the service server 202 establishes service session with the mobile terminal 200, and performs service response.

In step S216, the service server 202 delivers service data to the mobile terminal 200 via the default router 201.

The default router 201 looks up an FIB table of an IPv6 packet to route the IPv6 packet. The default router 201 also performs service control by examining a flow label, a source address, i.e., the IPv6 address of the mobile terminal 200, and a destination address, i.e., the IPv6 address of the service server 202 of the IPv6 header 223.

Particularly, the flow label uses a label value set in step S213 in which the default router 201 requests the service from the service server 202.

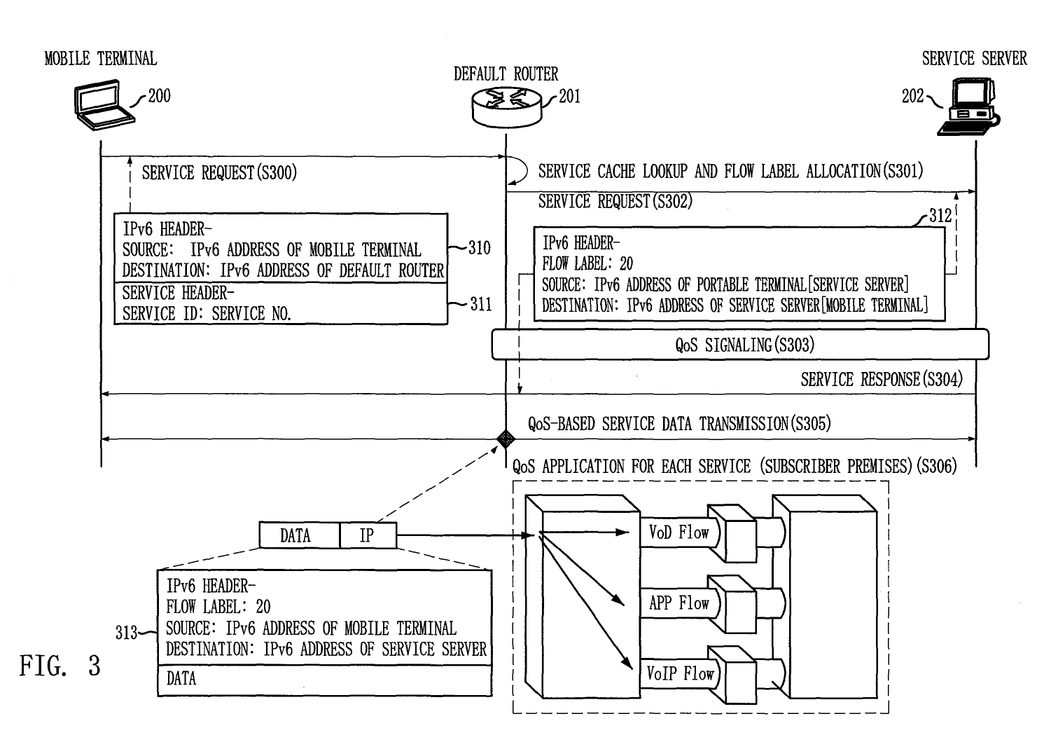

FIG. 3 is a flow diagram of a process of performing a quality of service (QoS) service by using a service header in accordance with an embodiment of the present invention.

Referring to FIG. 3, in step 300, a mobile terminal 200 requests a service from a default router 201 by sending an IPv6 packet including an IPv6 header 310 including a service header 311. In the IPv6 header 310, a source address is an IPv6 address of the mobile terminal 200, and a destination address is an IPv6 address of the default router 201. The service header 311 includes a service ID, i.e., a service number.

In step S301, when receiving the IPv6 packet from the mobile terminal 200, the default router 201 looks up a service cache that the default router 201 manages by using the service ID of the service header 311. The service cache may include not only an IPv6 address of the service server 202 but also associated service control information. Particularly, in step S301, the default router 201 learns a QoS value of the associated service control information to assign a flow label to the IPv6 header 312.

In step S302, the default router 201 changes the destination address to an IPv6 address of a service server 202 in the IPv6 header 312 of the IPv6 packet received from the mobile terminal 200 and from which the service header is stripped off, and requests a service from the service server 202. For the service request, the default router 201 routs the IPv6 packet to the service server 202.

In step S303, the default router performs signaling for QoS control with the service server 202.

In steps S304 and 5305, the service server 202 performs service response to the mobile terminal 200 to establish QoS-based service data communications between the mobile terminal 200 and the service server 202.

In step S306, the default router 201 examines an IPv6 header 313 of an IPv6 packet transmitted from the mobile terminal 200 to determine a flow label, an IPv6 source address and an IPv6 destination address, thereby applying QoS for each service. QoS information of the service is reserved through QoS signaling in step S303 between the default router 201 and the service server 202.

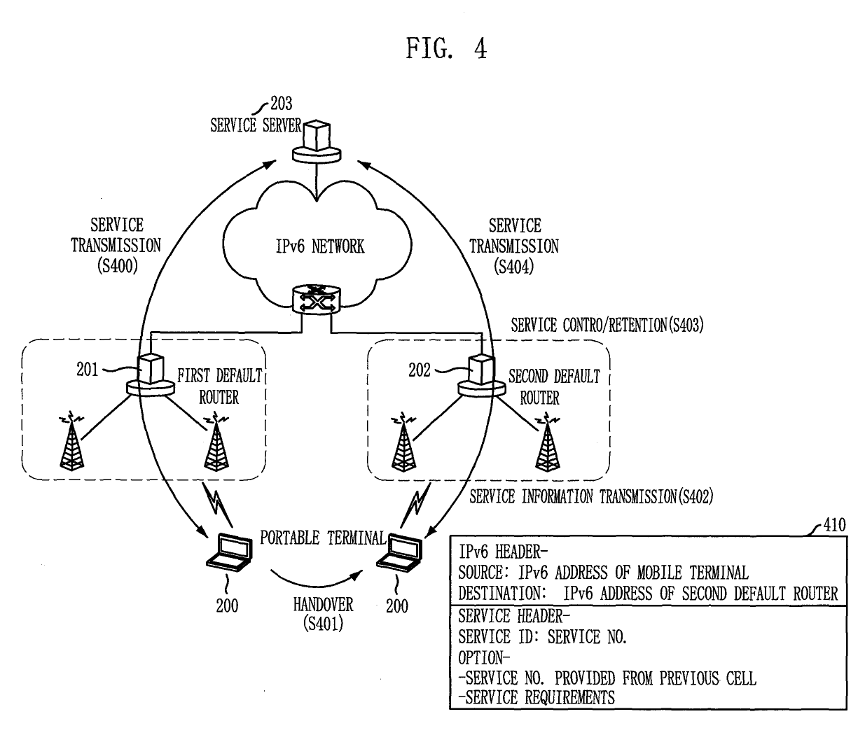

FIG. 4 is a view for explaining a process of performing handover of a mobile terminal by using a service header in accordance with an embodiment of the present invention.

In step S400, a mobile terminal 200 is in communication with a service server 203 via a default router over a fixed-mobile convergence network in which a wired network, and a wireless network, e.g., a wireless local area network (WLAN), or a wireless broadband Internet technology (WiBro) are converged.

Thereafter, when the mobile terminal 200 moves to a new IP subnet and thus performs handover in step S401, the mobile terminal 200 modifies an IPv6 packet 410 sent at the time of service request to the first default router 201, and then sends the IPv6 packet 410 to a second default router 202 in step S402. That is, the mobile terminal 200 changes a destination address of the IPv6 packet 410 from an IPv6 address of the first default router 201 to an IPv6 address of the second default router 202. A service header of the IPv6 packet 410 includes QoS information required by the mobile terminal, and initial access information required by the second default router 202 at the time of handover.

In step S403, the second default router 202 recognizes service requirements required for initial access and handover by using the service header of the IPv6 packet, and performs service control/retention such as channel allocation in the wireless network, and bandwidth allocation in the wired network.

In step S404, the second default router 202 removes the service header of the IPv6 packet, and sends the IPv6 packet having an IPv6 address of the service server 203 as a destination address of the IPv6 header, thereby establishing IPv6 communication for the service between the service server 203 and the mobile terminal 200.

The service header is extensible to support the handover of the mobile terminal 200 in the fixed-mobile convergence network.

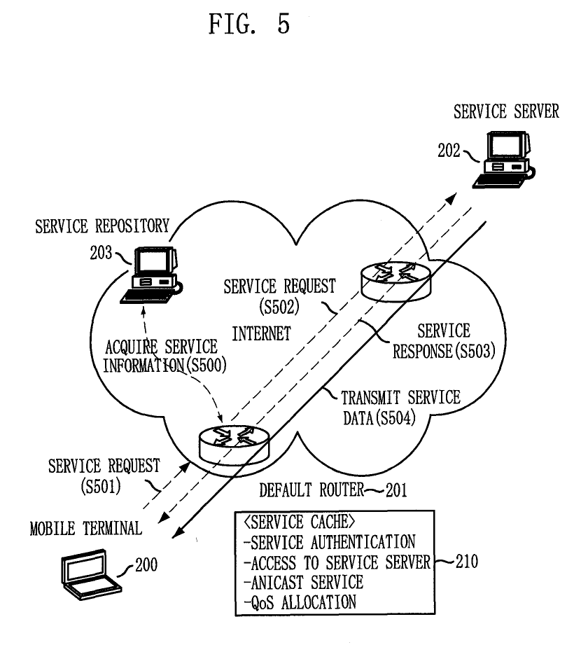

FIG. 5 is a view for explaining a process of performing a service for IPv6 communications between a mobile terminal 200 and a service server 202 by using a service header in accordance with an embodiment of the present invention.

In step S501, the mobile terminal 200 performs a service request by transmitting an IPv6 packet. In the IPv6 packet, a destination address of an IPv6 header is an IPv6 address of a default router 201, and a service ID is indicated in a service header.

The default router 201 acquires an IPv6 address of the service server 202 by looking up a service cache 201 using the service ID of the IPv6 packet received from the mobile terminal 200. The default router 201 removes the service header of the IPv6 packet, and changes a destination address of the IPv6 header from the IPv6 address of the default router 201 to an IPv6 address of the service server 202.

Thereafter, the default router 201 performs service request to the service server 202 in step S502, service response in step S503, and service data transmission in step S504 in the same manner as the IPv6 routing. For example, when the IPv6 address of the service server 202 is an IPv6 anycast address, the default router 201 performs IPv6 anycast routing instead of IPv6 unicast routing to deliver the IPv6 packet to the service server 202.

Additionally, various servers may act as the service server 202, such as a VOD server, an IPTV server, a VOIP server, a home agent server, and a policy server.

Also, the service cache 210 may include various service control information for service authentication, QoS allocation, filtering, server access, an anycast service, and a virtual private network (VPN) service. The service access includes, for example, access to VOD/VOIP/IPTV/authentication/home agent.

The service cache 210 may be defined as a default value in the default router 201. In step S500, the service cache 201 may acquire and store service information from a service repository at the time of initialization.

As described above, the technology of the present invention can be realized as a program and stored in a computer-readable recording medium, such as CD-ROM, RAM, ROM, floppy disk, hard disk and magneto-optical disk. Since the process can be easily implemented by those skilled in the art of the present invention, further description will not be provided herein.

While the present invention has been described with respect to certain preferred embodiments, it will be apparent to those skilled in the art that various changes and modifications may be made without departing from the scope of the invention as defined in the following claims.

What is claimed is:

1. A service recognition method of a router in an Internet protocol version 6 (IPv6) environment including a mobile terminal transmitting an IPv6 packet to request service, and a service server responding to a service request, the service recognition method comprising the steps of:
a) looking up a predefined service cache by using a service identification (ID) of an IPv6 packet as an index key of the service cache when the IPv6 packet including the service ID in a service header is received from the mobile terminal;
b) changing a destination address to an address of the service server when the address of the service server and service control information are determined through the lookup of the service-cache, to request a service and perform service control; and
c) performing routing to the mobile terminal by using the IPv6 packet when there is a service response from the service server.

2. The method of claim 1, further comprising the step of:
d) performing signaling for quality of service (QoS) control with the service server after the step b).

3. The method of claim 1, wherein the step c) includes the step of:
c1) examining a flow label, an address of the mobile terminal, and an address of the service server of the IPv6 packet to perform service control.

4. The method of claim 1, wherein the service ID is a predefined protocol port number or a newly defined service number.

5. The method of claim 1, wherein the service cache includes a table of the service control information.

6. The method of claim 1, wherein the service header of the IPv6 packet follows a predefined IPv6 extension header format, and is placed at the last of an alignment order of an IPv6 extension header and in front of an upper layer header.

7. The method of claim 1, wherein the service control information includes quality of service (QoS) information for assigning a flow label of an IPv6 header.

8. The method of claim 1, wherein the service control information includes a service requirement for initial access and handover.
